(19) United States
(12) Patent Application Publication
(10) Pub. No.: US 2025/0128772 A1
(43) Pub. Date: Apr. 24, 2025

(54) OPERATOR CABIN SUPPORT ASSEMBLY FOR AN AGRICULTURAL HARVESTER

(71) Applicant: CNH Industrial America LLC, New Holland, PA (US)

(72) Inventors: Bin Lou, Bolingbrook, IL (US); Panos Tamamidis, Northbrook, IL (US); Kai Zhao, Hinsdale, IL (US); Djamil Boulahbal, Plainfield, IL (US); Jishan Jin, Naperville, IL (US)

(21) Appl. No.: 18/493,222

(22) Filed: Oct. 24, 2023

(51) Int. Cl. B62D 33/06; A01D 41/12

(52) U.S. Cl. CPC B62D 33/0617; A01D 41/12; B62D 33/0608

(57) ABSTRACT

A harvester extends along a longitudinal direction, a lateral direction, and a vertical direction. The harvester includes a frame and a grain tank positioned above, and supported relative to, the frame. Moreover, the harvester includes an operator cabin extending between a forward side and an aft side and between an upper portion and a lower portion. The operator cabin is positioned above the frame and forward of the grain tank. Additionally, the harvester includes a coupling member coupling the operator cabin to the frame. The coupling member is mounted to the lower portion of the operator cabin. Furthermore, the harvester includes a damping member coupled between the grain tank and the upper portion of the operator cabin. The damping member is configured to limit motion of the coupling member relative to the frame during operations.

### FIELD OF THE INVENTION

The present disclosure generally relates to agricultural harvesters and, more particularly, to an operator cabin support assembly for an agricultural harvester.

### BACKGROUND OF THE INVENTION

A harvester is an agricultural machine used to harvest and process crops. For instance, a combine harvester may be used to harvest grain crops, such as wheat, oats, rye, barley, corn, soybeans, and flax or linseed. In general, the objective is to complete several processes, which traditionally were distinct, in one pass of the machine over a portion of the field. In this respect, most harvesters are equipped with a detachable header or harvesting implement, which cuts and collects the crop from the field. The harvester also includes a crop processing system, which performs various processing operations (e.g., threshing, separating, etc.) on the harvested crop received from the harvesting implement. Furthermore, the harvester includes an agricultural storage compartment, such as a crop or grain tank, which receives and stores the harvested crop after processing.

The harvester includes an operator's cabin supported on the frame of the harvester for housing an operator and the controls of the harvester. During harvesting operations, various components of the harvester, such as the sieves, may oscillate and create fore-to-aft and/or side-to-side motions of the operator's cabin relative to the frame. Such motion may be significant enough to cause discomfort to the operator and/or disruption of the harvesting operations. In this respect, many harvesters include various assemblies to reduce motion of the operator's cabin. While such assemblies work well, further improvements are needed.

Accordingly, an improved operator cabin support assembly for an agricultural harvester would be welcomed in the technology.

### SUMMARY OF THE INVENTION

Aspects and advantages of the technology will be set forth in part in the following description, or may be obvious from the description, or may be learned through practice of the technology.

In one aspect, the present subject matter is directed to an operator cabin support assembly for an agricultural vehicle. The agricultural vehicle extends along a longitudinal direction parallel to a direction of travel of the agricultural vehicle. The agricultural vehicle further extends along a lateral direction perpendicular to the longitudinal direction and along a vertical direction perpendicular to the longitudinal direction and the lateral direction. The operator cabin support assembly includes a frame and an agricultural storage compartment supported relative to the frame and positioned above the frame in the vertical direction. Additionally, the operator cabin support assembly includes an operator cabin extending between a forward side and an aft side along the longitudinal direction and extending between an upper portion and a lower portion along the vertical direction. The operator cabin is positioned above the frame in the vertical direction and forward of the agricultural storage compartment in the longitudinal direction. Furthermore, the operator cabin support assembly includes a coupling member coupling the operator cabin to the frame. The coupling member is mounted to the lower portion of the operator cabin. Moreover, the operator cabin support assembly includes a damping member coupled between the agricultural storage compartment and the upper portion of the operator cabin. The damping member is configured to limit motion of the coupling member relative to the frame during operations.

In a further aspect, the present subject matter is directed to an agricultural harvester. The agricultural harvester extends along a longitudinal direction parallel to a direction of travel of the agricultural harvester. The agricultural harvester further extends along a lateral direction perpendicular to the longitudinal direction and along a vertical direction perpendicular to the longitudinal direction and the lateral direction. The agricultural harvester includes a frame, a threshing and separating assembly configured to process cut crop material, and a grain tank supported relative to the frame and positioned above the frame in the vertical direction. Additionally, the agricultural harvester includes an operator cabin extending between a forward side and an aft side along the longitudinal direction and extending between an upper portion and a lower portion along the vertical direction. The operator cabin is positioned above the frame in the vertical direction and forward of the grain tank in the longitudinal direction. Furthermore, the agricultural harvester includes a coupling member coupling the operator cabin to the frame. The coupling member is mounted to the lower portion of the operator cabin. Moreover, the agricultural harvester includes a damping member coupled between the grain tank and the upper portion of the operator cabin. The damping member is configured to limit motion of the coupling member relative to the frame during operations.

These and other features, aspects and advantages of the present technology will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present technology, including the best mode thereof, directed to one of ordinary skill in the art, is set forth in the specification, which makes reference to the appended figures, in which:

FIG. 1 illustrates a partial sectional side view of one embodiment of an agricultural vehicle in accordance with aspects of the present subject matter;

FIG. 2 illustrates a perspective view of an operator cabin support assembly for an agricultural vehicle in accordance with aspects of the present subject matter;

FIG. 3 illustrates a side view of an operator's cabin shown in FIG. 2 experiencing fore-to-aft motion;

FIG. 4 illustrates a front view of the operator's cabin shown in FIG. 2 experiencing side-to-side motion;

FIG. 5 illustrates a perspective view of another embodiment of the operator cabin support assembly for an agricultural vehicle in accordance with aspects of the present subject matter, particularly illustrating first and second damping members coupled between an operator's cabin of the agricultural vehicle and an agricultural storage compartment of the agricultural vehicle;

FIG. 6 illustrates a top view of the embodiment of the operator cabin support assembly shown in FIG. 5;

FIG. 7 illustrates a perspective view of the embodiment of the operator cabin support assembly shown in FIG. 2, particularly illustrating a single damping member coupled between an operator's cabin of the agricultural vehicle and an agricultural storage compartment of the agricultural vehicle; and

FIG. 8 illustrates a top view of the embodiment of the operator cabin support assembly shown in FIGS. 2 and 7.

Repeat use of reference characters in the present specification and drawings is intended to represent the same or analogous features or elements of the present technology.

### DETAILED DESCRIPTION OF THE DRAWINGS

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

In general, the present subject matter is directed to an agricultural vehicle, such as an agricultural harvester. As will be described below, the agricultural vehicle may include an operator cabin support assembly including a grain tank supported relative to a frame of the agricultural vehicle and positioned above the frame. The grain tank may be configured to store crop material processed by a threshing and separating assembly of the grain tank. Additionally, the operator cabin support assembly may include an operator's cabin extending between a forward side and an aft side as well as between an upper portion and a lower portion. The operator's cabin may house the controls of the agricultural vehicle, such as the drive controls, and be configured to seat an operator of the agricultural vehicle. The operator's cabin may also be positioned above the frame of the agricultural vehicle and forward of the grain tank. One or more coupling members, such as coil springs, may be mounted to the lower portion of the operator's cabin and couple the operator's cabin to the frame of the agricultural vehicle.

Furthermore, the operator cabin support assembly includes one or more damping members configured to limit motion of the coupling members relative to the frame of the agricultural vehicle during operations. For example, in one embodiment, the one or more damping members may be one or more fluid-filled damping members (e.g., pneumatic shock absorbers). The damping member(s) may be coupled between the agricultural storage compartment and the upper portion of the operator's cabin. For example, in one embodiment, the operator cabin support assembly includes a single damping member orientated generally parallel to the direction of travel of the agricultural vehicle and coupled to the operator's cabin at a first anchor point and to the grain tank at a second anchor point. The first anchor point may be positioned on the aft side of the cabin. In another embodiment, the operator cabin support assembly includes first and second damping members coupled to the aft side and upper portion of the operator's cabin at a first and third anchor point, respectively, and coupled to the grain tank at a second and fourth anchor point, respectively. A first acute angle may be defined between the first damping member and the grain tank and a second acute angle may be defined between the second damping member and the grain tank.

The damping member(s) of the disclosed operator cabin support assembly improves the operation of the agricultural vehicle. More specifically, during operations, various components of the agricultural vehicle may oscillate relative to the frame of the agricultural vehicle. Such oscillation, in turn, causes the coupling member(s) and, thus, the operator's cabin, to move relative to the frame. One or more damping members limit motion (e.g., fore-to-aft, side-to-side) of the operator's cabin. Limited motion of the operator's cabin may, among other things, reduce operator discomfort. Furthermore, one or more damping members coupled to the upper portion of the operator's cabin and to the grain tank further improves operation of the agricultural vehicle by limiting motion (e.g., fore-to-aft, side-to-side) of the upper portion of the operator's cabin, which is where significant motion occurs.

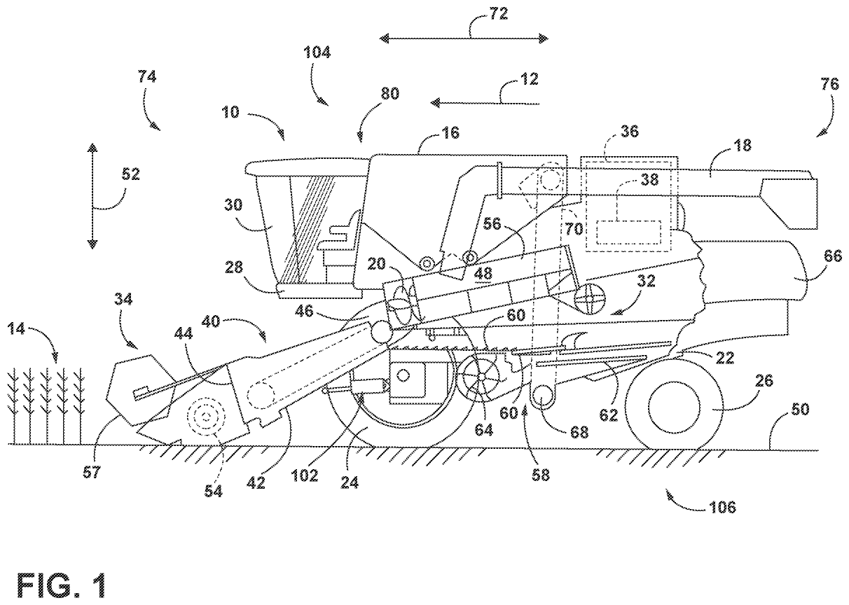

Referring now to the drawings, FIG. 1 illustrates a partial sectional side view of an agricultural vehicle 10. In the illustrated embodiment, the agricultural vehicle 10 is configured as an agricultural harvester. However, it should be appreciated the agricultural vehicle 10 may be configured as any other suitable agricultural vehicle.

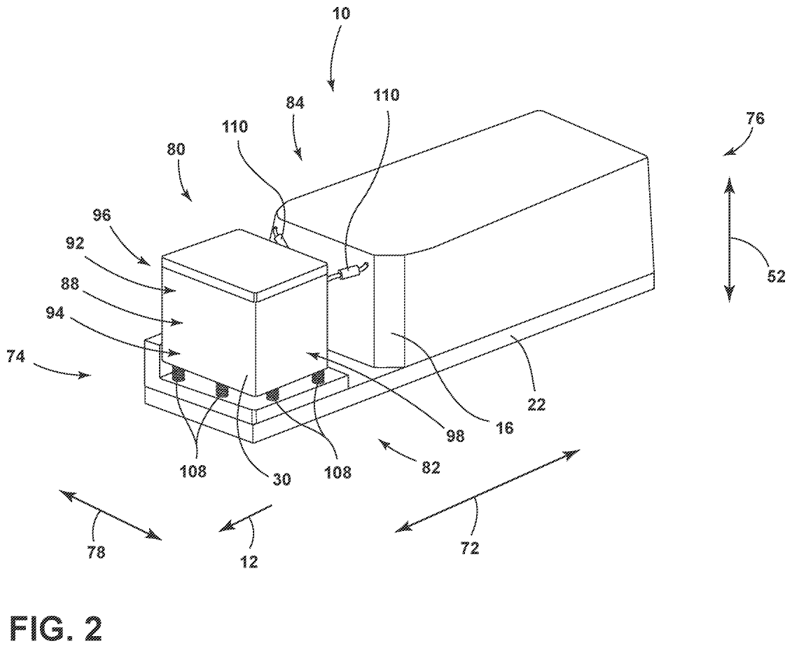

As shown in FIG. 1, the vehicle 10 extends along a longitudinal direction (indicated by arrow 72) between a forward end 74 of the vehicle 10 and an aft end 76 of the vehicle 10. The longitudinal direction 72, in turn, generally extends parallel to a forward direction of travel (indicated by arrow 12) of the vehicle 10. Additionally, the vehicle 10 extends along a lateral direction (indicated by arrow 78) (FIG. 2) between a first side 82 (FIG. 2) of the vehicle 10 and a second side 84 (FIG. 2) of the vehicle 10. The lateral direction 78 (FIG. 2), in turn, generally extends perpendicular to the longitudinal direction 72. Furthermore, the vehicle 10 extends along a vertical direction (indicated by arrow 52) between a top end 104 and a bottom end 106.

Additionally, the vehicle 10 includes an operator cabin support assembly 80. The operator cabin support assembly 80 of the vehicle 10 includes a chassis or main frame 22 configured to support and/or couple to various components of the vehicle 10. For example, in several embodiments, the vehicle 10 may include a pair of driven, front wheels 24 and a pair of steerable, rear wheels 26 coupled to the frame 22. As such, the wheels 24, 26 may be configured to support the vehicle 10 relative to the ground and move the vehicle 10 in the forward direction of travel 12.

The vehicle 10 may be configured to travel across a field in the direction of travel 12 to harvest a crop 14. While traversing the field, the vehicle 10 may be configured to process and store the harvested crop within an agricultural storage compartment 16, such as a grain tank, of the operator's cabin support assembly 80. The agricultural storage compartment 16 may be supported relative to the frame 22 and may be positioned above the frame 22 in the vertical direction 52. Furthermore, the harvested crop may be unloaded from the agricultural storage compartment 16 for receipt by the crop receiving vehicle (not shown) via a crop discharge tube 18 of the vehicle 10. Moreover, in the illustrated embodiment, the vehicle 10 is configured as an axial-flow type combine in which the harvested crop is threshed and separated while being advanced by and along a longitudinally arranged rotor 20. However, in alternative embodiments, the vehicle 10 may have any other suitable vehicle configuration, such as a traverse-flow type configuration.

Furthermore, the vehicle 10 may include a crop processing system 32 and the crop discharge tube 18 supported by the frame 22. Additionally, the operator cabin support assembly 80 includes an operator's cabin 30 supported by the frame 22. Moreover, the vehicle 10 may include an operator's platform 28 adjacent to the operator's cabin 30 such that an operator of the vehicle 10 can access the operator's cabin 30. As will be described below, the crop processing system 32 may be configured to perform various processing operations on the harvested crop as the crop processing system 32 transfers the harvested crop between a harvesting implement 34 (e.g., a header) of the vehicle 10 and the agricultural storage compartment 16. Furthermore, the vehicle 10 may include an engine 36 and a transmission 38 mounted on the frame 22. The transmission 38 may be operably coupled to the engine 36 and may provide variably adjusted gear ratios for transferring engine power to the wheels 24 via a drive axle assembly (or via axles if multiple drive axles are employed).

Furthermore, as shown in FIG. 1, the vehicle 10 includes a feeder 40 that couples to and supports the harvesting implement 34. More specifically, the feeder 40 may include a feeder housing 42 extending from the forward end 44 to an aft end 46. In this respect, the forward end 44 of the feeder housing 42 may, in turn, be coupled to the harvesting implement 34. Moreover, the aft end 46 of the feeder housing 42 may be pivotably coupled to the frame 22 adjacent to a threshing and separating assembly 48 of the crop processing system 32. Such a pivotable coupling may permit movement of the harvesting implement 34 relative to a field surface 50 and the frame 22 in the vertical direction 52. Additionally, the vehicle 10 may include a plurality of actuators (one of which may include an actuator 102) configured to adjust the position of the harvesting implement 34 relative to the frame 22 and/or the field surface 50 along multiple degrees of freedom.

As the vehicle 10 is propelled in the forward direction of travel 12 over the field with the crop 14, the crop material is severed from the stubble by one or more knives (not shown) positioned on the cutter bar 57 at the front of the harvesting implement 34. The knife(ves) (not shown) may oscillate to sever the crop material from the stubble, which, as will be described below, causes the operator's cabin 30 to vibrate, rock, and/or otherwise move. The crop material is delivered by a header auger 54 to the forward end 44 of the feeder housing 42, which supplies the harvested crop to the threshing and separating assembly 48. In general, the threshing and separating assembly 48 may include a cylindrical chamber 56 in which the rotor 20 is rotated to thresh and separate the harvested crop received therein. That is, the harvested crop is rubbed and beaten between the rotor 20 and the inner surfaces of the chamber 56 to loosen and separate the grain, seed, or the like from the straw.

The harvested crop separated by the threshing and separating assembly 48 may fall onto a crop cleaning assembly 58 of the crop processing system 32. In general, the crop cleaning assembly 58 may include a series of pans 60 and associated sieves 62. In general, the separated harvested crop may be spread out via the oscillation of pans 60 and/or sieves 62 and may eventually fall through apertures defined by the sieves 62. The oscillation of the pans 60 and/or the sieves 62 may, as will be described below, cause the operator's cabin 30 to vibrate, rock, and/or otherwise move. Additionally, a cleaning fan 64 may be positioned adjacent to one or more of the sieves 62 to provide an air flow through the sieves 62 that removes chaff and other impurities from the harvested crop. For instance, the fan 64 may blow the impurities off the harvested crop for discharge from the vehicle 10 through the outlet of a straw hood 66 positioned at the back end of the vehicle 10. The cleaned harvested crop passing through the sieves 62 may then fall into a trough of an auger 68, which may be configured to transfer the harvested crop to an elevator 70 for delivery to the crop tank 16. It should be appreciated that the configuration of the agricultural vehicle 10 described above and shown in FIG. 1 is provided only to place the present subject matter in an exemplary field of use. Thus, it should be appreciated that the present subject matter may be readily adaptable to any manner of agricultural vehicle configuration.

Referring now to FIG. 2, a perspective view of one embodiment of an operator cabin support assembly 80 for an agricultural vehicle is illustrated. The operator cabin support assembly 80 will be described herein in the context of the agricultural vehicle 10 described above but can be implemented with any suitable agricultural vehicle configuration.

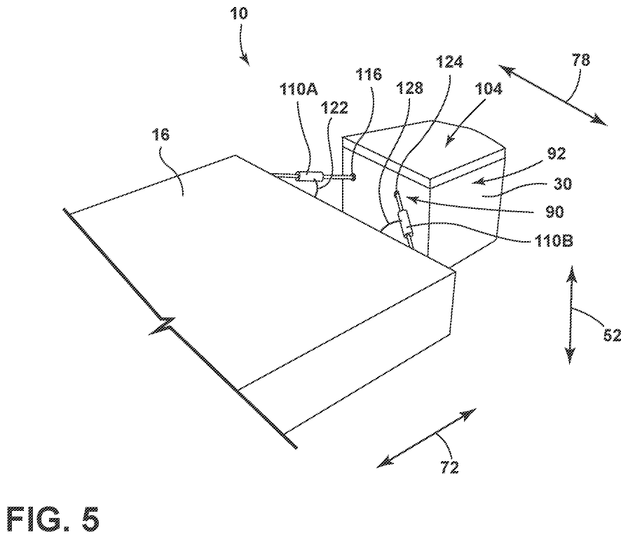

As shown in FIG. 2, the operator's cabin 30 of the operator cabin support assembly 80 extends between a forward side 88 and an aft side 90 (FIG. 5, 7) along the longitudinal direction 72. Additionally, the operator's cabin 30 extends between an upper portion 92 and a lower portion 94 along the vertical direction 52. Moreover, the operator's cabin 30 extends between a first side 96 and a second side 98 along the lateral direction 78. The operator's cabin 30 may be positioned above the frame 22 in the vertical direction 52 and forward of the agricultural storage compartment 16 in the longitudinal direction 72.

Additionally, the operator cabin support assembly 80 of the vehicle 10 may include one or more coupling members 108 coupling the operator's cabin 30 to the frame 22 of the vehicle 10. During operations, components of the vehicle 10, such as the sieves 62, may oscillate. In this respect, as will be described below, the oscillation of the components of the vehicle 10 may cause the coupling member(s) 108 and, thus, the operator's cabin 30, to vibrate, rock, and/or otherwise move. Such movement of the operator's cabin 30, among other things, creates discomfort to the operator within the operator's cabin 30.

It should be appreciated that the coupling member(s) 108 may be configured as any suitable kind of coupling member to couple the operator's cabin 30 to the frame 22 of the vehicle 10. For example, as shown in FIG. 2, the coupling member(s) 108 is configured as a coil spring(s) mounted to the lower portion 94, such as a bottom end, of the operator's cabin 30 at one end of the coil spring(s) and to the frame 22 of the vehicle 10 at a different end of the coil spring(s). However, it should be appreciated that the coupling member(s) 108 may be configured as any other suitable coupling member for coupling the operator's cabin 30 to the frame 22 of the vehicle 10.

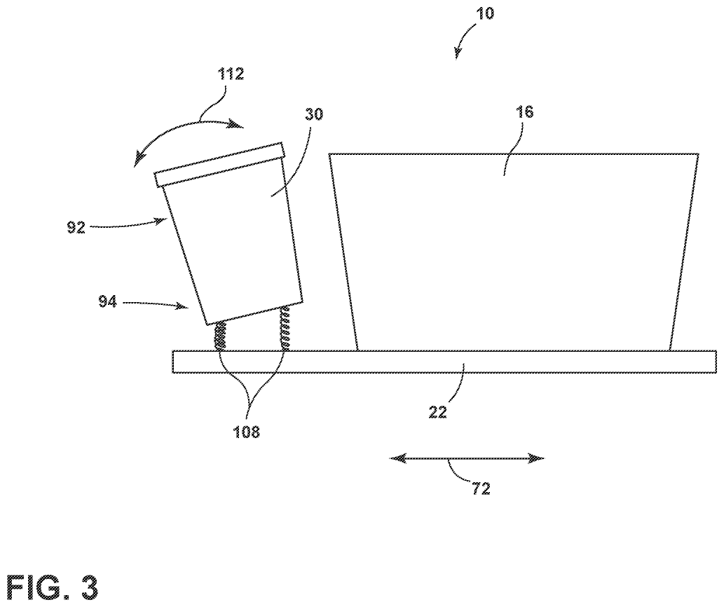

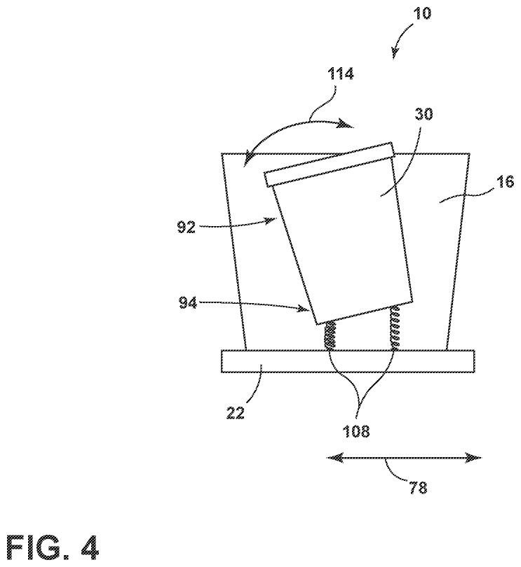

Referring now to FIGS. 3 and 4, differing views of the coupling members 108 and the operator's cabin 30 of the operator cabin support assembly 80 shown in FIG. 2 are illustrated. In particular, FIG. 3 illustrates a side view of the operator's cabin 30 and the coupling members 108 experiencing fore-to-aft motion. FIG. 4 illustrates a front view of the operator's cabin 30 and the coupling members 108 experiencing side-to-side motion.

During harvesting operations, the components of the vehicle 10 may oscillate, causing the coupling member(s) 108 and the operator's cabin 30 to move. For example, as shown in FIG. 3, the oscillation of the components may cause the coupling member(s) 108 to move such that the operator's cabin 30 rocks in a fore-to-aft motion (as indicated by arrow 112) along the longitudinal direction 72. Since the coupling member(s) 108 couple the lower portion 94 of the operator's cabin 30 to the frame 22 of the vehicle 10, the upper portion 92 of the operator's cabin 30 experiences a larger range of fore-to-aft motion than the lower portion 94.

Additionally, or alternatively, as shown in FIG. 4, the oscillation of the components may cause the coupling member(s) 108 and the operator's cabin 30 to rock in a side-to-side motion (as indicated by arrow 114) along the lateral direction 78. Since the coupling member(s) 108 couple the lower portion 94 of the operator's cabin 30 to the frame 22 of the vehicle 10, the upper portion 92 of the operator's cabin 30 experiences a larger range of side-to-side motion than the lower portion 94.

Referring again to FIG. 2, the operator cabin support assembly 80 may include one or more damping members 110 coupled between the agricultural storage compartment 16 and the upper portion 92 of the operator's cabin 30. As will be described below, the damping member(s) 110 are configured to limit motion of the coupling member(s) 108 relative to the frame 22 of the vehicle 10 and, thus, limit motion of the operator's cabin 30 relative to the frame 22 during harvesting operations.

It should be appreciated that the damping member(s) 110 may be configured as any suitable kind of damping member to limit motion of the coupling member(s) 108 relative to the frame 22 of the vehicle 10. For example, as shown in FIG. 2, the damping member(s) 110 may be configured as a fluid-filled damping member(s), such as a pneumatic shock absorber(s). However, it should be appreciated that the damping member(s) 110 may be configured as any other suitable damping member(s) configured to limit motion of the coupling member(s) 108 relative to the frame 22 of the vehicle 10.

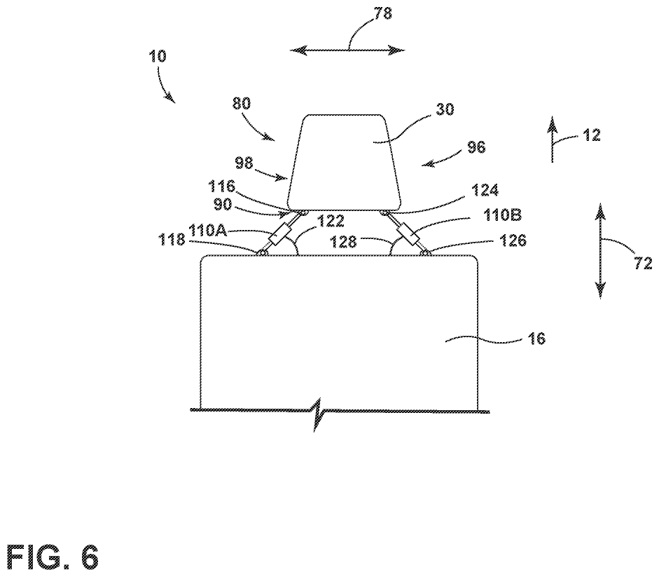

Referring now to FIGS. 5 and 6, differing views of an embodiment of the operator cabin support assembly 80 shown in FIG. 2 are illustrated. In particular, FIG. 5 illustrates a perspective view of a first damping member 110A and a second damping member 110B coupled between the operator's cabin 30 and the agricultural storage compartment 16. FIG. 6 illustrates a top view of the embodiment shown in FIG. 5.

The first damping member 110A may be coupled between the agricultural storage compartment 16 and the upper portion 92 of the operator's cabin 30 at a first anchor point 116 and a second anchor point 118 (FIG. 6). As shown in FIG. 5, the first anchor point 116 is positioned on the aft side 90 of the operator's cabin 30 and on the upper portion 92 of the operator's cabin 30. The first anchor point 116 may be configured as a coupling component defined by the aft side 90 of the operator's cabin 30, such as a mounting bracket, for the first damping member 110A to be coupled to. However, it should be appreciated that the first anchor point 116 may be configured as any suitable coupling component such that the first damping member 110A may be coupled thereto.

Furthermore, as shown in FIG. 6, the second anchor point 118 is positioned on the agricultural storage compartment 16. The second anchor point 118 may be configured as a coupling component defined by the agricultural storage compartment 16, such as a mounting bracket, for the first damping member 110A to be coupled to. However, it should be appreciated that the second anchor point 118 may be configured as any suitable coupling component such that the first damping member 110A may be coupled thereto.

Additionally, the first anchor point 116 and the second anchor point 118 (FIG. 6) may be positioned relative to each other such that the first damping member 110A may be coupled to the first and second anchor points 116, 118. For example, in one embodiment, the first and second anchor points 116, 118 may be positioned relative to each other such that a first acute angle 122 is defined within a plane defined by the longitudinal direction 72 and the lateral direction 78 by the first damping member 110A and the agricultural storage compartment 16. The first acute angle 122 may be between 30 and 60 degrees, such as 40 and 50 degrees. However, it should be appreciated that the first and second anchor points 116, 118 may be positioned relative to each other in any suitable manner such that the first damping member 110A may be coupled to the first and second anchor points 116, 118.

Additionally, the second damping member 110B may be coupled between the agricultural storage compartment 16 and the upper portion 92 of the operator's cabin 30 at a third anchor point 124 and a fourth anchor point 126 (FIG. 6). As shown in FIG. 5, the third anchor point 124 is positioned on the aft side 90 of the operator's cabin 30 and on the upper portion 92 of the operator's cabin 30. The third anchor point 124 may be configured as a coupling component defined by the aft side 90 of the operator's cabin 30, such as a mounting bracket, for the second damping member 110B to be coupled to. However, it should be appreciated that the third anchor point 124 may be configured as any suitable coupling component such that the second damping member 110B may be coupled thereto. Additionally, the third anchor point 124 may be spaced apart from the first anchor point 116 in the lateral direction 78.

Moreover, as shown in FIG. 6, the fourth anchor point 126 is positioned on the agricultural storage compartment 16. The fourth anchor point 126 may be configured as a coupling component defined by the agricultural storage compartment 16, such as a mounting bracket, for the second damping member 110B to be coupled to. However, it should be appreciated that the fourth anchor point 126 may be configured as any suitable coupling component such that the second damping member 110B may be coupled thereto. Additionally, the fourth anchor point 126 may be spaced apart from the second anchor point 118 in the lateral direction 78.

Additionally, the third anchor point 124 and the fourth anchor point 126 (FIG. 6) may be positioned relative to each other such that the second damping member 110B may be coupled to the third and fourth anchor points 124, 126. For example, in one embodiment, the third and fourth anchor points 124, 126 may be positioned relative to each other such that a second acute angle 128 is defined within a plane defined by the longitudinal direction 72 and the lateral direction 78 by the second damping member 110B and the agricultural storage compartment 16. The second acute angle 128 may be between 30 and 60 degrees, such as 40 and 50 degrees. However, it should be appreciated that the third and fourth anchor points 124, 126 may be positioned relative to each other in any suitable manner such that the second damping member 110B may be coupled to the third and fourth anchor points 124, 126.

In this respect, the first and second damping members 110A, 110B are configured to limit fore-to-aft motion of the operator's cabin 30 at the upper portion 92 where a larger range of fore-to-aft motion of the operator's cabin 30 occurs as opposed to the lower portion 94 of the operator's cabin 30.

Furthermore, as shown in FIG. 6, the first and second acute angles 122, 128 may face each other. In this respect, opposing directions of forces provided by the first and second damping members 110A. 110B on the upper portion 92 of the operator's cabin 30 allow the first and second damping members 110A, 110B to provide increased reduction in fore-to-aft and side-to-side motion, such as a clockwise or counterclockwise twisting motion, of the operator's cabin 30.

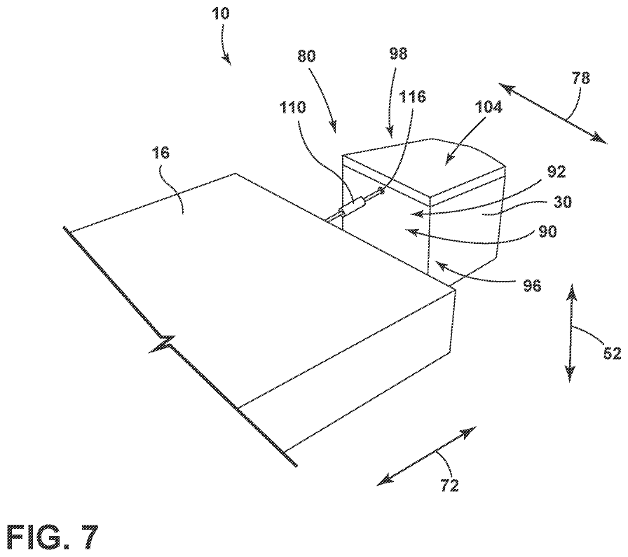

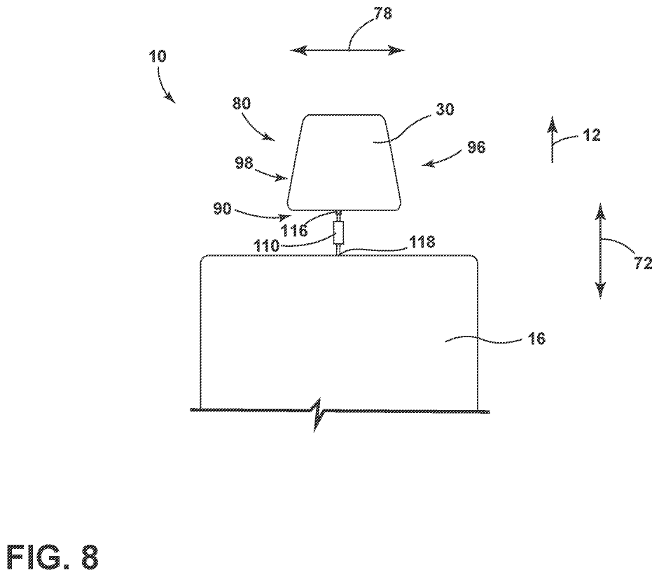

Referring now to FIGS. 7 and 8, differing views of an alternative embodiment of the operator cabin support assembly 80 shown in FIG. 2 are illustrated. In particular, FIG. 7 illustrates a perspective view of a single damping member 110 coupled between the operator's cabin 30 and the agricultural storage compartment 16. FIG. 8 illustrates a top view of the embodiment shown in FIG. 7.

As shown, the single damping member 110 is coupled between the agricultural storage compartment 16 and the upper portion 92 of the operator's cabin 30. For example, the damping member 110 may be coupled to a first anchor point 116 and a second anchor point 118 (FIG. 8). In some embodiments, the first anchor point 116 is positioned on the aft side 90 of the operator's cabin 30 and the upper portion 92 of the operator's cabin 30. Furthermore, in some embodiments, the second anchor point 118 is positioned on the agricultural storage compartment 16. The first anchor point 116 may be configured as a coupling component defined by the aft side 90 of the operator's cabin 30, such as a mounting bracket, for the damping member 110 to be coupled to. Likewise, the second anchor point 118 (FIG. 8) may be configured as a coupling component defined by the agricultural storage compartment 16, such as a mounting bracket, for the damping member 110 to be coupled to. However, it should be appreciated that the first and second anchor points 116, 118 may be configured as any suitable coupling component such that the damping member 110 may be coupled thereto. In this respect, the damping member 110 is configured to limit fore-to-aft motion of the operator's cabin 30 at the upper portion 92 where a larger range of fore-to-aft motion of the operator's cabin 30 occurs compared to the lower portion 94.

Moreover, as shown in FIG. 8, the first anchor point 116 and the second anchor point 118 may be positioned relative to each other such that the damping member 110 may be parallel to the direction of travel 12 of the vehicle 10. For example, the first and second anchor points 116, 118 may be aligned with each other in the lateral direction 78 and the vertical direction 52 (FIG. 7). In this respect, the damping member 110 is configured to further limit fore-to-aft motion, such as clockwise or counterclockwise twisting motion, of the of the operator's cabin 30.

This written description uses examples to disclose the technology, including the best mode, and also to enable any person skilled in the art to practice the technology, including making and using any devices or systems and performing any incorporated methods. The patentable scope of the technology is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

1. An operator cabin support assembly for an agricultural vehicle, the agricultural vehicle extending along a longitudinal direction parallel to a direction of travel of the agricultural vehicle, the agricultural vehicle further extending along a lateral direction perpendicular to the longitudinal direction and along a vertical direction perpendicular to the longitudinal direction and the lateral direction, the operator cabin support assembly comprising:
a frame;
an agricultural storage compartment supported relative to the frame and positioned above the frame in the vertical direction;
an operator cabin extending between a forward side and an aft side along the longitudinal direction and extending between an upper portion and a lower portion along the vertical direction, the operator cabin positioned above the frame in the vertical direction and forward of the agricultural storage compartment in the longitudinal direction;
a coupling member coupling the operator cabin to the frame, the coupling member mounted to the lower portion of the operator cabin; and
a damping member coupled between the agricultural storage compartment and the upper portion of the operator cabin, the damping member configured to limit motion of the coupling member relative to the frame during operations.

2. The operator cabin support assembly of claim 1, wherein the damping member is coupled between the agricultural storage compartment and the upper portion of the operator cabin at a first anchor point positioned on the agricultural storage compartment and a second anchor point positioned on the operator cabin.

3. The operator cabin support assembly of claim 1, wherein the damping member is configured to limit motion of the coupling member relative to the frame in at least one of a first direction or a second direction differing from the first direction.

4. The operator cabin support assembly of claim 3, wherein the second direction extends perpendicular to the first direction.

5. The operator cabin support assembly of claim 1, wherein the damping member is parallel to the direction of travel of the agricultural vehicle.

6. The operator cabin support assembly of claim 1, wherein the damping member corresponds to a first damping member coupled between the aft side of the operator cabin and the agricultural storage compartment, the operator cabin support assembly further comprising:
a second damping member configured to further limit the motion of the coupling member relative to the frame during the operations, the second damping member coupled between the agricultural storage compartment and the aft side and the upper portion of the operator cabin.

7. The operator cabin support assembly of claim 6, wherein a first acute angle is defined within a plane defined by the longitudinal direction and the lateral direction by the first damping member and the agricultural storage compartment, and a second acute angle is defined within the plane defined by the longitudinal direction and the lateral direction by the second damping member and the agricultural storage compartment.

8. The operator cabin support assembly of claim 7, wherein the first acute angle and the second acute angle are each between 30 and 60 degrees.

9. The operator cabin support assembly of claim 1, wherein the damping member comprises a fluid-filled damping member.

10. The operator cabin support assembly of claim 9, wherein the fluid-filled damping member is a pneumatic shock absorber.

11. An agricultural harvester extending along a longitudinal direction parallel to a direction of travel of the agricultural harvester, the agricultural harvester further extending along a lateral direction perpendicular to the longitudinal direction and along a vertical direction perpendicular to the longitudinal direction and the lateral direction, the agricultural harvester comprising:
a frame;
a threshing and separating assembly configured to process cut crop material;
a grain tank supported relative to the frame and positioned above the frame in the vertical direction;
an operator cabin extending between a forward side and an aft side along the longitudinal direction and extending between an upper portion and a lower portion along the vertical direction, the operator cabin positioned above the frame in the vertical direction and forward of the grain tank in the longitudinal direction;
a coupling member coupling the operator cabin to the frame, the coupling member mounted to the lower portion of the operator cabin; and
a damping member coupled between the grain tank and the upper portion of the operator cabin, the damping member configured to limit motion of the coupling member relative to the frame during operations.

12. The agricultural harvester of claim 11, wherein the damping member is coupled between the grain tank and the upper portion of the operator cabin at a first anchor point positioned on the grain tank and a second anchor point positioned on the operator cabin.

13. The agricultural harvester of claim 11, wherein the damping member is configured to limit motion of the coupling member relative to the frame in at least one of a first direction or a second direction differing from the first direction.

14. The agricultural harvester of claim 13, wherein the second direction extends perpendicular to the first direction.

15. The agricultural harvester of claim 11, wherein the damping member is parallel to the direction of travel of the agricultural harvester.

16. The agricultural harvester of claim 11, wherein the damping member corresponds to a first damping member coupled between the aft side of the operator cabin and the grain tank, the agricultural harvester further comprising:
a second damping member configured to further limit the motion of the coupling member relative to the frame during the operations, the second damping member coupled between the grain tank and the aft side and the upper portion of the operator cabin.

17. The agricultural harvester of claim 16, wherein a first acute angle is defined within a plane defined by the longitudinal direction and the lateral direction by the first damping member and the grain tank, and a second acute angle is defined within the plane defined by the longitudinal direction and the lateral direction by the second damping member and the grain tank.

18. The agricultural harvester of claim 17, wherein the first acute angle and the second acute angle are each between 30 and 60 degrees.

19. The agricultural harvester of claim 11, wherein the damping member comprises a fluid-filled damping member.

20. The agricultural harvester of claim 19, wherein the fluid-filled damping member is a pneumatic shock absorber.
